(19) United States
(12) Patent Application Publication
(10) Pub. No.: US 2015/0355528 A1
(43) Pub. Date: Dec. 10, 2015

(54) STROBE APPARATUS

(71) Applicant: PANASONIC INTELLECTUAL PROPERTY MANAGEMENT CO., LTD., Osaka (JP)

(72) Inventors: TAKASHI KITAMURA, Osaka (JP); KATSUNORI KAWABATA, Kyoto (JP); HIRO AOKI, Osaka (JP)

(21) Appl. No.: 14/759,210

(22) PCT Filed: Jan. 8, 2014
(86) PCT No.: PCT/JP2014/000025

§ 371 Date: Jul. 3, 2015

(30) Foreign Application Priority Data
Jan. 11, 2013 (JP) 2013-003393

(51) Int. Cl. G03B 15/05; F21V 5/04; F21V 13/04; F21V 7/00

(52) U.S. Cl. CPC G03B 15/05; F21V 7/005; F21V 5/04; F21V 13/04

(57) ABSTRACT

The strobe device of the present invention is provided with a light source, a reflector, and an optical panel. Reflector is provided with a side opening and a front opening. The optical panel has: wedge-shaped side light guide sections that are integrally formed with both side portions of an incidence-side lens surface; and planar side reflecting sections that are integrally formed with both side portions of an object-side lens surface. Consequently, the strobe device having a reduced thickness and a reduced size is provided.

### TECHNICAL FIELD

The present invention relates to a strobe device used for photography for example.

### BACKGROUND ART

Conventionally, this type of strobe device generally includes: a flash discharge tube; a reflector that reflects light emitted from the flash discharge tube to irradiate the light toward the front side; and an optical panel that distributes light from a light source and the reflector toward an object. The reflector is configured so that both ends have side panels to adjust the distribution of radiation light radiated in a longitudinal direction of the flash discharge tube. The optical panel has an increased longitudinal size in order to obtain a sufficient distribution in the longitudinal direction of the flash discharge tube.

In recent years, strobe devices having a reduced size and a reduced thickness have been a mainstream. Thus, an approach has been made to provide a reduced size by eliminating the side panels of the reflector and by limiting the longitudinal size of the optical panel.

However, in the case of the above strobe device configuration composed of the reflector and the optical panel, since the reflected light by the side panels of the reflector is not obtained, it is impossible to expand the distribution in a left-and-right direction (longitudinal direction). Specifically, radiation light cannot be radiated from within a sufficient emission area of the strobe device. Thus, vignetting of the radiation light from the flash discharge tube occurs in a part having no appearance face of the optical panel (optically-effective region). This has caused a disadvantage of the unavailability of a desired distribution angle in the left-and-right direction.

Thus, in order to solve the above disadvantage, a strobe device has been suggested that can provide a small size and a reduced loss of emission light intensity by improving an optical panel (see for example Patent Publication 1).

The following section will describe the strobe device disclosed in Patent Publication 1 with reference to a reflector and an optical panel in particular.

The reflector is configured so that a vertical cross section orthogonal to a tube axis of a flash discharge tube functioning as a light source has a substantially-U-like curved shape. Thus, the reflector has a front opening opened at the front side and side openings at both ends.

An optical panel has an incidence-side lens surface and an emission-side lens surface. Both left and right side ends of the incidence-side lens surface have side face reflecting portions integrated with the incidence-side lens surface. The incidence-side lens surface and the emission-side lens surface are configured by a convex lens having a lens surface having the positive power.

The side face reflecting portion of the optical panel is formed to have a wedge shape so that the side face reflecting portion is tapered toward the light source side. Furthermore, the side face reflecting portion has a side face incidence face at the light axis side and a side face reflecting face at an opposite side of the light axis. The side face incidence face is formed to have a side face incidence angle (about 5 degrees) with regard to a vertical cross section orthogonal to the tube axis of the light source (Y-Z direction). On the other hand, the side face reflecting face is formed to have a side face reflection angle (about 25 degrees) with regard to a vertical cross section orthogonal to the tube axis of the light source (Y-Z direction).

An interval between one intersection line and the other intersection line of the lens surface and the side face incidence face (an interval between side face incidence faces at both ends (an interval between the lens surface and a boundary with the side face incidence face) is farther away (or longer) than the arc length of the flash discharge tube.

In the strobe device having the above configuration, first, peripheral light emitted to the periphery of the side opening of the reflector enters the side face incidence face. Thereafter, the peripheral light having entered the side face incidence face is totally-reflected by the side face reflecting face and penetrates through the interior of the side face reflecting portion. Then, the peripheral light having penetrated through the side face reflecting portion is emitted from the emission-side lens surface and is irradiated to an irradiated body at the front side without being totally-reflected by the emission-side lens surface.

However, in the case of the strobe device disclosed in Patent Publication 1, the wedge-shaped side face reflecting portions having a predetermined angle to the vertical cross section are individually provided at both ends of the optical panel. Thus, the optical panel has a longitudinal size extremely longer relative to the arc length of the flash discharge tube, thus resulting in a strobe device having a larger size.

Furthermore, the optical panel includes the convex lens. Thus, when the interval between the optical panel and the reflector is reduced, the distribution of the flash discharge tube in an up-and-down direction is insufficient. As a result, the strobe device has been suppressed from having a reduced thickness.

When a component such as a trigger coil is provided just beside the reflector, a component such as the trigger coil can be seen from the exterior through the optical panel, thus resulting in a disadvantageous appearance.

### CITATION LIST

Patent Literature 1

Japanese Patent Unexamined Publication No. 2002-296647

### SUMMARY OF THE INVENTION

In view of the above, the present invention provides a strobe device that can provide a reduced size and a reduced thickness.

Specifically, the present invention is a strobe device comprising: a light source; a reflector that reflects light emitted from the light source to irradiate the light forward; and an optical panel for distributing the light from the light source and the reflector toward an object. The reflector includes a side opening and a front opening. The optical panel has: wedge-shaped side light guide sections integrated with an incidence-side lens surface at both ends of the incidence-side lens surface toward the light source side; and planer side reflecting sections integrated with an object-side lens surface at both ends of the object-side lens surface so as to have elevation surfaces with respect to the length direction of the light source. Radiation light emitted to the side opening of the reflector is configured so that the light enters the incidence face of the side light guide section and is subsequently totally-reflected by the reflecting face of the side reflecting section and penetrates through the interior of the optical panel to be emitted from the object-side lens surface.

According to this configuration, the radiation light emitted to the side light guide section of the reflector enters the wedge-shaped incidence face of the side light guide section. Thereafter, the radiation light having entered the incidence face of the side light guide section is totally-reflected by the side reflecting section and penetrates through the interior of the optical panel to be emitted from the object-side lens surface. Thus, the light can be irradiated to the irradiated body at the front side with a wide angle without being totally-reflected by the object-side lens surface. As a result, the optical panel can have a smaller longitudinal size. Specifically, since a conventional strobe device has a side opening in a reflector, in order to cause light beam passing through the side opening to be totally-reflected, the side reflecting section must be positioned to be farther. However, the present invention eliminates the need to position the side reflecting section to be farther. Specifically, the strobe device can have a reduced size.

Furthermore, the optical panel does not have to use a convex lens. Thus, the reflector and the optical panel can have therebetween a reduced interval. As a result, a sufficient distribution angle can be obtained in the up-and-down direction of the flash discharge tube, thus resulting in a strobe device having a reduced thickness.

### BRIEF DESCRIPTION OF THE DRAWINGS

FIG. 1 is a perspective view illustrating the entire strobe device according to an exemplary embodiment of the present invention.

FIG. 2 is a cross-sectional view illustrating the strobe device according to the exemplary embodiment taken along line 2-2 of FIG. 1.

FIG. 3 is an exploded perspective view illustrating the entire strobe device according to the exemplary embodiment.

FIG. 4 illustrates the distribution status of peripheral light of the strobe device according to the exemplary embodiment.

FIG. 5 illustrates the distribution characteristic in a left-and-right direction of the strobe device according to the exemplary embodiment.

### DESCRIPTION OF EMBODIMENTS

The following section will describe an exemplary embodiment of the present invention with reference to the drawings. It is noted that the invention is not limited by this exemplary embodiment.

### Exemplary Embodiment

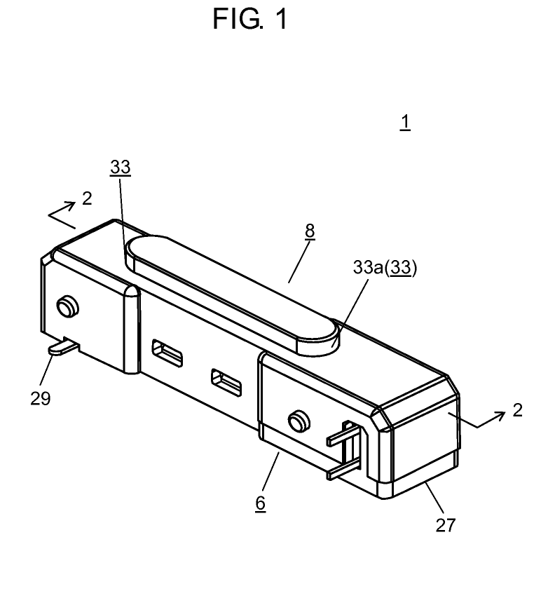

The following section will describe the configuration of a strobe device according to an exemplary embodiment of the present invention with references to FIGS. 1 to 3.

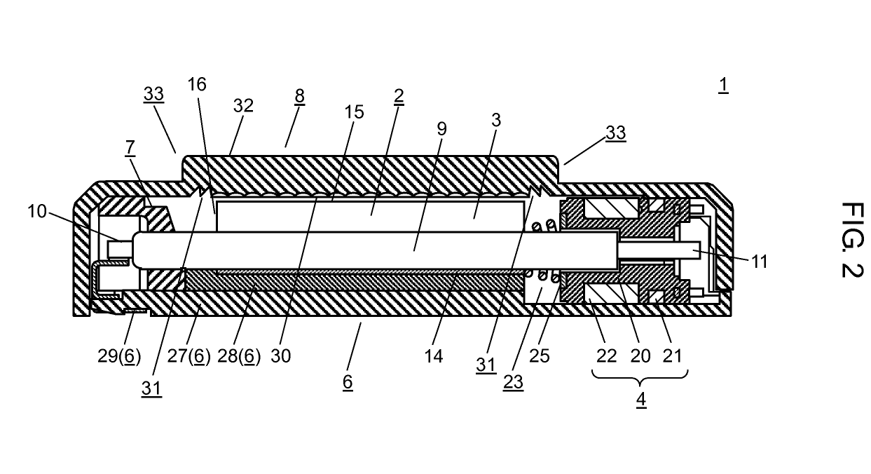

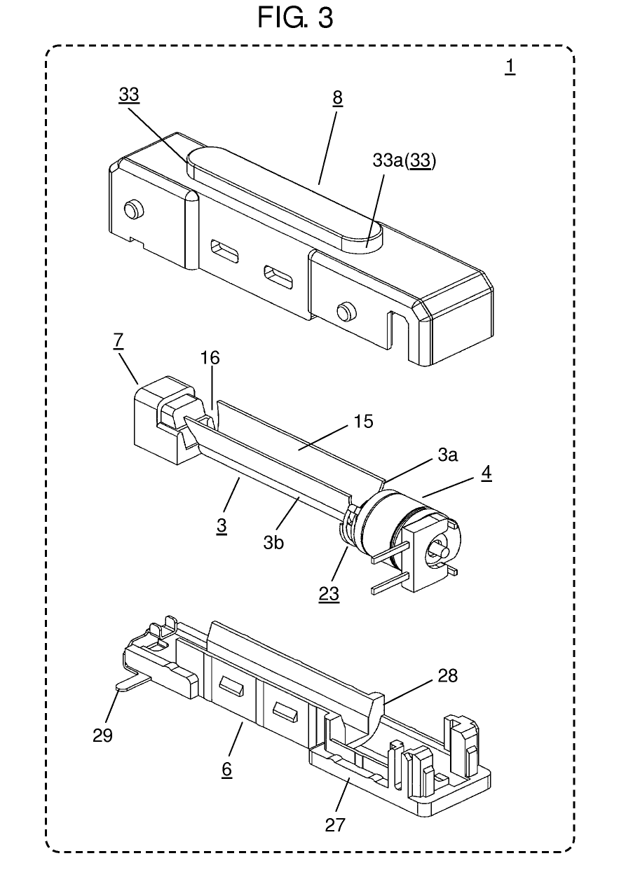

FIG. 1 is a perspective view illustrating the entire strobe device according to an exemplary embodiment of the present invention. FIG. 2 is a cross-sectional view illustrating the strobe device according to the exemplary embodiment taken along line 2-2 of FIG. 1. FIG. 3 is an exploded perspective view illustrating the entire strobe device according to the exemplary embodiment.

As shown in FIG. 1 to FIG. 3, strobe device 1 of this exemplary embodiment is composed of: at least flash discharge tube 2 as a light source for radiating light; reflector 3; trigger coil 4; base 6; bushing 7; and optical panel 8. Reflector 3 has an electrical conductivity and accommodates therein a part of flash discharge tube 2 and functions as a trigger external electrode of flash discharge tube 2. Trigger coil 4 is provided at the other end of flash discharge tube 2. Base 6 accommodates therein reflector 3. Bushing 7 fixes one end of flash discharge tube 2 to base 6. Optical panel 8 is formed of translucent material and is combined with base 6 to thereby retain reflector 3.

Flash discharge tube 2 is composed of: cylindrical glass bulb 9 filled with noble gas such as xenon at a predetermined pressure; anode 10 provided at one end; and cathode 11 provided at the other end. Flash discharge tube 2 is configured so that electrons collide with the filled noble gas to generate radiation light and the generated radiation light is radiated to the exterior via reflector 3 for example.

Anode 10 is configured by a bar-like electrode, is welded via glass beads (not shown), and is fixed to one end of glass bulb 9 while penetrating therethrough. On the other hand, cathode 11 is welded via glass beads (not shown) and is fixed to the other end of glass bulb 9 while penetrating therethrough.

Reflector 3 includes bottom portion 14 abutted to an outer periphery of flash discharge tube 2 as well as front opening 15 and side opening 16 through which light radiated from flash discharge tube 2 is radiated to the exterior. Reflector 3 functions as a trigger external electrode for flash discharge tube 2. Front opening 15 of reflector 3 has a wide opening approximately corresponding to the effective length of flash discharge tube 2 (light source) (which corresponds to the substantial length of a light-emitting region).

Trigger coil 4 includes tubular core 20, primary winding 21 wound around the outer periphery of core 20, and secondary winding 22 having one end connected to the other end of primary winding 21 and being wound around the outer periphery of core 20.

Reflector 3 and trigger coil 4 are electrically connected via conductive body 23 such as a spring. Conductive body 23 is inserted to flash discharge tube 2 and is sandwiched between secondary terminal 25 of trigger coil 4 and side face 3a of reflector 3 while being compressed in an axis line direction. This electrically connects secondary winding 22 of trigger coil 4 to reflector 3.

As shown in FIG. 3, base 6 is composed of, at least body 27 having an insulation property, elastic body 28, and anode terminal 29. Elastic body 28 is provided at the inner side of body 27 and is abutted to outer periphery 3b of bottom portion 14 of reflector 3. Anode terminal 29 is connected to anode 10 of flash discharge tube 2 and is protruded to have a plate-like shape to constitute an external terminal. Body 27 of base 6 accommodates reflector 3 for example and is fitted in optical panel 8. This causes elastic body 28 of base 6 to be elastically deformed and reflector 3 is sandwiched between elastic body 28 and optical panel 8.

Optical panel 8 has incidence-side lens surface 30 for entering radiation light radiated from flash discharge tube 2 and object-side lens surface 32 for emitting the radiation light to an irradiated body. Incidence-side lens surface 30 has side light guide sections 31 at both sides thereof. Side light guide section 31 is integrated with incidence-side lens surface 30 to form a wedge shape so as to be tapered toward flash discharge tube 2 (light source) side.

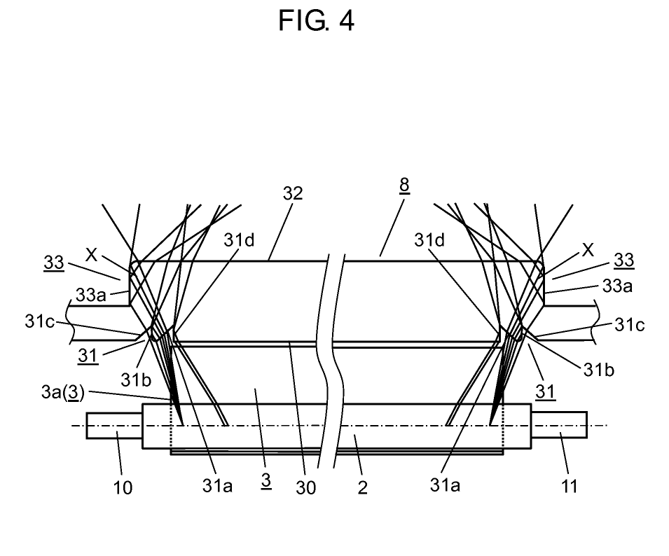

As shown in FIG. 4, side light guide section 31 of incidence-side lens surface 30 has first incidence face 31a and first irradiation face 31b forming two sides of the wedge shape. First incidence face 31a is provided, with regard to the length direction of flash discharge tube 2, to have a predetermined angle (an inclination angle of 45 degrees in this exemplary embodiment). On the other hand, first irradiation face 31b is provided, with regard to the length direction of flash discharge tube 2, to have an elevation surface (at 90 degrees in this exemplary embodiment). In this exemplary embodiment, incidence-side lens surface 30 has second incidence face 31c opposed to first irradiation face 31b and second irradiation face 31d opposed to first incidence face 31a. Second incidence face 31c is provided, with regard to the length direction of flash discharge tube 2, to have a predetermined angle (an inclination angle of 45 degrees in this exemplary embodiment (i.e., an angle parallel to first incidence face 31a)). On the other hand, second irradiation face 31d is provided, with regard to the length direction of flash discharge tube 2 (at 90 degrees in this exemplary embodiment (i.e., an angle parallel to first irradiation face 31b)).

More specifically, as shown in FIG. 4, incidence-side lens surface 30 has long right triangle-like grooves (or two such grooves in this exemplary embodiment) in a direction orthogonal to the length direction of flash discharge tube 2 (radial direction). Specifically, second irradiation face 31d, first incidence face 31a, first irradiation face 31b, and second incidence face 31c are formed in this order from the center side in the length direction of flash discharge tube 2 to the outer side in the longitudinal direction.

In this configuration, second irradiation face 31d formed at the innermost side of incidence-side lens surface 30 is formed at the same or substantially the same position as that of side face 3a of reflector 3 in the length direction of flash discharge tube 2. On the other hand, second incidence face 31c formed at the outermost side of incidence-side lens surface 30 is formed, in the length direction of flash discharge tube 2, at the inner side of side reflecting sections 33 formed at both ends of object-side lens surface 32 (which will be described later).

Although the above section has described a case where incidence-side lens surface 30 has two right triangle-like grooves, the invention is not limited to this. One or three or more such groove(s) also may be formed. When three grooves are provided for example, a third irradiation face, a first incidence face, a first irradiation face, a second incidence face, a second irradiation face, and a third incidence face will be formed in this order from the center side of the length direction of flash discharge tube 2 to the outer side in the longitudinal direction.

Object-side lens surface 32 of incidence-side lens surface 30 is formed to have a planer shape. Object-side lens surface 32 has side reflecting sections 33 at both ends thereof. As shown in FIG. 1 or FIG. 3, reflecting face 33a of side reflecting section 33 is formed to have a semicircular arc shape in a planer view, thereby providing an improved design.

The optical panel of this exemplary embodiment has a configuration as described above.

The following section will specifically describe the action of optical panel 8 with reference to FIG. 4.

As shown in FIG. 4, peripheral light X, which is radiation light emitted to the periphery of side opening 16 of reflector 3, partially enters second incidence face 31c of side light guide section 31 formed at incidence-side lens surface 30. Thereafter, peripheral light X having entered second incidence face 31c is totally-reflected by reflecting face 33a of side reflecting section 33 formed at object-side lens surface 32. On the other hand, most of peripheral light X enters optical panel 8 from an end of incidence-side lens surface 30 (an end of incidence-side lens surface 30 close to second irradiation face 31d) and first incidence face 31a. Thereafter, incident peripheral light X is totally-reflected by second irradiation face 31d, first irradiation face 31b, and reflecting face 33a of side reflecting section 33 formed at object-side lens surface 32.

Specifically, according to strobe device 1 of this exemplary embodiment, peripheral light X moving to side opening 16 of reflector 3 can be totally-reflected by side light guide section 31 provided at optical panel 8 and side reflecting section 33 and can be irradiated to the irradiated body. This can consequently take in the radiation light radiated from the flash discharge tube in an efficient manner and can prevent vignetting from occurring to provide irradiation toward the object side.

According to strobe device 1 of this exemplary embodiment, peripheral light X having entered wedge-shaped first incidence face 31a of side light guide section 31 is partially reflected to first irradiation face 31b. At the same time, the other part of peripheral light X is totally-reflected by reflecting face 33a of side reflecting section 33. Thus, optical panel 8 can have a reduced size in the longitudinal direction, thus allowing the strobe device to have a reduced size. Furthermore, since optical panel 8 can have a reduced size in the longitudinal direction, trigger coil 4 provided just beside flash discharge tube 2 is prevented from being seen from the exterior through optical panel 8.

Also according to strobe device 1 of this exemplary embodiment, optical panel 8 does not have to use a convex lens. Thus, reflector 3 and optical panel 8 can have therebetween a reduced interval. As a result, a sufficient distribution can be obtained in the up-and-down direction of the flash discharge tube, thus resulting in a strobe device having a reduced thickness.

Also according to strobe device 1 of this exemplary embodiment, object-side lens surface 32 of optical panel 8 can have a planer shape. As a result, radiation light having entered optical panel 8 can be irradiated to the irradiated body at the front side with a wide angle without being reflected by object-side lens surface 32, thus providing a lightly-irradiated area around the irradiated body.

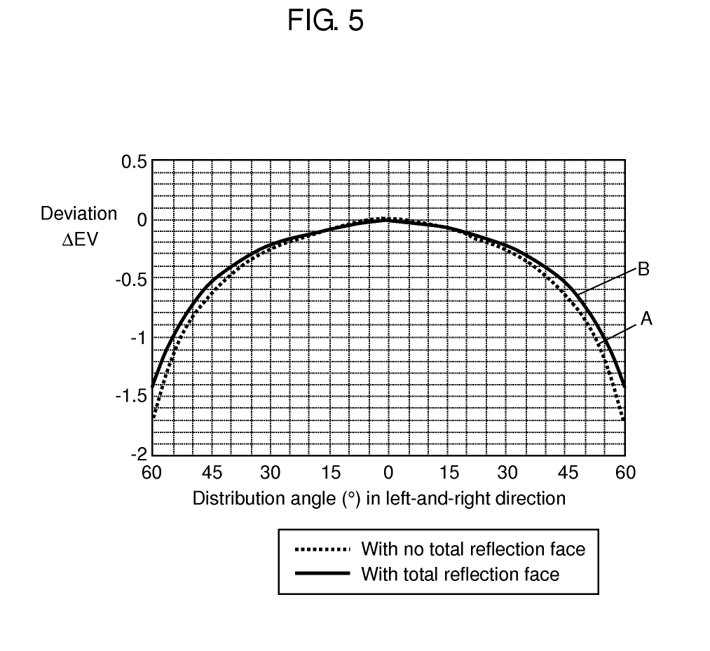

The following section will describe the distribution characteristic of strobe device 1 according to this exemplary embodiment with reference to FIG. 5 and (Table 1).

FIG. 5 illustrates the distribution characteristic in the left-and-right direction of the strobe device according to the exemplary embodiment.

FIG. 5 shows the relation between deviation ΔEV and the distribution angle in the left-and-right direction when the center of the distribution angle in the left-and-right direction is assumed as 0EV. A strobe device having side light guide section 31 is represented by curve B of a solid line while strobe device having no side light guide section 31 is represented by curve A of a dotted line.

As can be seen from FIG. 5, the distribution characteristic shown by curve A shows a characteristic having a relatively-steep distribution angle in the left-and-right direction. On the other hand, the distribution characteristic shown by curve B shows a characteristic having a relatively gradual distribution angle in the left-and-right direction than curve A.

(Table 1) shows the distribution characteristic in the up-and-down direction and the distribution characteristic in the left-and-right direction of the strobe device having side light guide section 31 and the strobe device having no side light guide section 31. (Table 1) is based on an assumption that the strobe device having side light guide section 31 is represented as “with total reflection face” while the strobe device having no side light guide section 31 is represented as “with no total reflection face”.

TABLE 1

| | Distribution angle (−0.5 Ev) | | | | | |
|---|---|---|---|---|---|---|
| | | | Total of | | | Total of |
| | | | up and | | | left and |
| | Up | Down | down | Left | Right | right |
| With no total | 33.53 | 34.14 | 67.67 | 41.85 | 41.27 | 83.12 |
| reflection face | | | | | | |
| With total | 34.34 | 34.05 | 68.39 | 45.29 | 45.18 | 90.47 |
| reflection face | | | | | | |

As can be seen from (Table 1), the strobe device having no side light guide section 31 shows that the total value of the distribution characteristic in the up-and-down direction is 67.67. On the other hand, the strobe device having side light guide section 31 shows that the total value of the distribution characteristic in the up-and-down direction is 68.39.

The strobe device having no side light guide section 31 shows that the total value of the distribution characteristic in the left-and-right direction is 83.12. On the other hand the strobe device having side light guide section 31 shows that the total value of the distribution characteristic in the left-and-right direction is 90.47.

As can be seen from FIG. 5 and the result of (Table 1) shown above, when the strobe device having side light guide section 31 is compared with the strobe device having no side light guide section 31, the former can increase the distribution angle in the left-and-right direction and the distribution angle in the up-and-down direction. Specifically, by allowing a strobe device to include side light guide section 31 of this exemplary embodiment, the strobe device can have a superior distribution characteristic.

The strobe device according to the present invention is not limited to the above exemplary embodiment and may be subjected to various changes within a scope not deviating from the scope of the present invention. Furthermore, configurations and methods for example shown below according to various modification examples also may be arbitrarily selected and used with configurations and methods according to the above exemplary embodiments for example.

For example, strobe device 1 of the above exemplary embodiment has been described by way of a configuration example in which no thin film transparent electrode is provided on the surface of flash discharge tube 2. However, the invention is not limited to this. For example, a configuration may be used in which a thin film transparent electrode is provided on the surface of flash discharge tube 2. This configuration also can sufficiently irradiate an irradiated body with radiation light radiated from flash discharge tube 2.

Strobe device 1 of the above exemplary embodiment has been described by way of a configuration in which the other end of flash discharge tube 2 is inserted to core 20 of trigger coil 4. However, the invention is not limited to this. For example, a configuration also may be used in which one end of flash discharge tube 2 is inserted to core 20 of trigger coil 4.

As described above, the present invention is a strobe device including a light source, a reflector that reflects light emitted from the light source to irradiate the light forward, and an optical panel for distributing the light from the light source and the reflector toward an object. The reflector includes a side opening and a front opening. The optical panel has: wedge-shaped side light guide sections integrated with an incidence-side lens surface at both ends of the incidence-side lens surface toward the light source side; and planer side reflecting sections integrated with an object-side lens surface at both ends of the object-side lens surface so as to have elevation surfaces with respect to the length direction of the light source. Radiation light emitted to the side opening of the reflector is configured so that the light enters the incidence face of the side light guide section and is subsequently totally-reflected by the reflecting face of the side reflecting section and penetrates through the interior of the optical panel to be emitted from the object-side lens surface.

According to this configuration, the radiation light emitted to the side light guide section of the reflector enters the wedge-shaped incidence face of the side light guide section. Thereafter, the radiation light having entered the incidence face of the side light guide section is totally-reflected by the side reflecting section and penetrates through the interior of the optical panel to be emitted from the object-side lens surface. Thus, the light can be irradiated to the irradiated body at the front side with a wide angle without being totally-reflected by the object-side lens surface. As a result, the optical panel can have a smaller longitudinal size. Specifically, since a conventional strobe device has a side opening in a reflector, in order to cause light beam passing through the side opening to be totally-reflected, the side reflecting section must be positioned to be farther. However, the present invention eliminates the need to position the side reflecting section to be farther. Specifically, the strobe device can have a reduced size.

Furthermore, according to the above configuration, the optical panel does not have to use a convex lens. Thus, the reflector and the optical panel can have therebetween a reduced interval. As a result, a sufficient distribution angle can be obtained in the up-and-down direction of the flash discharge tube, thus resulting in a strobe device having a reduced thickness.

The strobe device of the present invention may be configured so that the trigger coil is provided at a side of the reflector.

According to this configuration, the optical panel includes side light guide sections formed at both ends of the incidence-side lens surface and side reflecting section formed at both ends of the object-side lens surface. Thus, the optical panel can have a reduced longitudinal size. Furthermore, the radiation light emitted to the periphery of the side light guide section of the reflector enters the wedge-shaped incidence face of the side light guide section and is subsequently totally-reflected by the side reflecting section to irradiate an irradiated body. Thus, vignetting can be prevented from occurring. This can prevent a trigger coil from being seen from the exterior through the optical panel. As a result, the trigger coil can be provided at a side (or just beside) the reflector.

The strobe device of the present invention also may be configured so that the optical panel has an object-side lens surface having a planer shape.

According to this configuration, the radiation light radiated from the light source is irradiated with a wide angle forward without being reflected by the object-side lens surface. As a result, such a strobe device can be realized that can lightly irradiate a peripheral area.

The strobe device of the present invention also may be configured so that the side light guide section has a wedge shape having a right triangle and a hypotenuse of the right triangle is opposed to the reflector. This can provide a further wider angle.

### INDUSTRIAL APPLICABILITY

The present invention provides a strobe device useful in photography for example because light radiated from a flash discharge tube can be irradiated with a wide angle.

### REFERENCE MARKS IN THE DRAWINGS

1 Strobe device
2 Flash discharge tube (light source)
3 Reflector
3a Side face
3b Outer periphery
4 Trigger coil
6 Base
7 Bushing
8 Optical panel
9 Glass bulb
10 Anode
11 Cathode
14 Bottom portion
15 Front opening
16 Side opening
20 Core
21 Primary winding
22 Secondary winding
23 Conductive body
25 Secondary terminal
27 Body
28 Elastic body
29 Anode terminal
30 Incidence-side lens surface
31 Side light guide section
31a First incidence face
31b First irradiation face
31c Second incidence face
31d Second irradiation face
32 Object-side lens surface
33 Side reflecting section
33a Reflecting face

1. A strobe device comprising:
a light source;
a reflector that reflects light emitted from the light source to irradiate the light forward; and
an optical panel for distributing the light from the light source and the reflector toward an object, wherein
the reflector includes a side opening and a front opening, and
the optical panel has wedge-shaped side light guide sections integrated with an incidence-side lens surface at both ends of the incidence-side lens surface toward the light source side, and side reflecting sections integrated with an object-side lens surface at both ends of the object-side lens surface so as to have elevation surfaces with respect to the length direction of the light source.

2. The strobe device according to claim 1, wherein a side face of the reflector has a trigger coil in which a primary winding and a secondary winding are wound on an outer periphery of a tubular core.

3. The strobe device according to claim 1, wherein the object-side lens surface of the optical panel has a planer shape.

4. The strobe device according to claim 1, wherein the side light guide section is formed of a wedge in a right triangle and the right triangle has a hypotenuse opposed to the reflector.
